(19) United States
(12) Patent Application Publication
(10) Pub. No.: US 2017/0259816 A1
(43) Pub. Date: Sep. 14, 2017

(54) VEHICLE CONTROL SYSTEM, VEHICLE CONTROL METHOD, AND VEHICLE CONTROL PROGRAM

(71) Applicant: Honda Motor Co., Ltd., Tokyo (JP)

(72) Inventor: Masanori Takeda, Wako-shi (JP)

(73) Assignee: Honda Motor Co., Ltd., Tokyo (JP)

(21) Appl. No.: 15/456,895

(22) Filed: Mar. 13, 2017

(30) Foreign Application Priority Data
Mar. 14, 2016 (JP) 2016-050190

(51) Int. Cl. B60W 30/095; B60W 30/16; B60W 10/20; B60W 30/09

(52) U.S. Cl. CPC B60W 30/0953; B60W 30/09; B60W 30/16; B60W 10/20; B60W 2420/42; B60W 2420/52; B60W 2720/10; B60W 2720/24; B60W 2520/06; B60W 2520/14; B60W 2550/10

(57) ABSTRACT

The present disclosure is a vehicle control system including: a detection section that detects a nearby object present in the surroundings of a vehicle; a generation section that generates a safety focused course focusing on safety and a plan achievability focused course focusing on fidelity to a preset plan, based on a position of a nearby object detected by the detection section; an evaluation/selection section that selects one course from out of the safety focused course or the plan achievability focused course generated by the generation section, based on a situation in the surroundings in which the vehicle is present; and a travel control section that automatically controls at least one from out of acceleration/deceleration or steering of the vehicle based on the course selected by the evaluation/selection section.

### CROSS REFERENCES TO RELATED APPLICATIONS

The present application claims priority under 35 U.S.C. §119 to Japanese Patent Application No. 2016-050190, filed Mar. 14, 2016, entitled “Vehicle Control System, Vehicle Control Method, and Vehicle Control Program”. The contents of this application are incorporated herein by reference in their entirety.

### BACKGROUND

1. Field

The present disclosure relates to a vehicle control system, a vehicle control method, and a vehicle control program.

2. Description of the Related Art

Recently, research is progressing in technology for controlling a vehicle so as to automatically travel along a route to its destination. A known drive support system related to this field includes an instruction section that instructs the start of self-driving of the vehicle by an operation of a driver, a setting section that sets a self-driving destination, a choosing section that chooses a self-driving mode based on whether or not a destination has been set in cases in which the instruction section has been operated by the driver, and a control section that controls the travel of the vehicle based on the self-driving mode chosen by the choosing section. In cases in which the destination has not been set, the choosing section chooses whether to perform self-driving so as to travel along the current travel route of the vehicle, or to automatically stop the vehicle, in the self-driving mode (see, for example, International Publication No. 2011/158347).

However, the related art is sometimes unable to precisely control vehicle travel according to the situation in the surroundings.

### SUMMARY

The present disclosure describes a vehicle control system, a vehicle control method, and a vehicle control program capable of precisely controlling travel of a vehicle according to the situation in the surroundings.

A vehicle control system of a first aspect of the disclosure includes: a detection section that detects a nearby object present in the surroundings of a vehicle; a generation section that generates a safety focused course focusing on safety and a plan achievability focused course focusing on fidelity to a preset plan, based on a position of a nearby object detected by the detection section; an evaluation/selection section that selects one course from out of the safety focused course or the plan achievability focused course generated by the generation section, based on a situation in the surroundings in which the vehicle is present; and a travel control section that automatically controls at least one from out of acceleration/deceleration or steering of the vehicle based on the course selected by the evaluation/selection section.

A second aspect of the disclosure describes the vehicle control system of the first aspect, wherein in cases in which the vehicle is envisaged to travel along the plan achievability focused course, the evaluation/selection section selects the plan achievability focused course generated by the generation section when the vehicle does not impinge on nearby objects and behavior of the vehicle does not exceed a set range.

A third aspect of the disclosure describes the vehicle control system of the second aspect, wherein in cases in which the vehicle is envisaged to travel along the plan achievability focused course, the evaluation/selection section selects the safety focused course generated by the generation section instead of the plan achievability focused course generated by the generation section when the vehicle impinges on nearby objects or when behavior of the vehicle exceeds a set range.

A fourth aspect of the disclosure describes the vehicle control system of the first aspect, wherein the evaluation/selection section derives an evaluation value of the plan achievability focused course generated by the generation section, and selects the safety focused course in cases in which the derived evaluation value of the plan achievability focused course is less than a reference value.

A fifth aspect of the disclosure describes the vehicle control system of the first aspect, wherein the evaluation/selection section derives evaluation values of the safety focused course and the plan achievability focused course generated by the generation section, and selects the safety focused course in cases in which the evaluation value of the safety focused course is higher than the evaluation value of the plan achievability focused course by a specific value or greater, even when the derived evaluation value of the plan achievability focused course is a reference value or greater.

A sixth aspect of the disclosure describes the vehicle control system of the first aspect, wherein the generation section generates the safety focused course based on a plan focusing on safety that has a specific evaluation value or greater for the fidelity the plan, and generates the plan achievability focused course based on a plan focusing on the fidelity to the plan that has a specific evaluation value or greater for safety, and the evaluation/selection section selects one course from out of the safety focused course or the plan achievability focused course generated by the generation section, based on a situation in the surroundings in which the vehicle is present.

A seventh aspect of the disclosure describes the vehicle control system of the first aspect, wherein the generation section changes course elements of a course with a high evaluation value for safety in a direction in which the evaluation value becomes higher to generate the safety focused course based on a plan having a local maximum evaluation value, and changes course elements of a course with a high evaluation value for the fidelity to the plan in a direction in which the evaluation value becomes higher to generate the plan achievability focused course based on a plan having a local maximum evaluation value.

An eighth aspect of the disclosure describes the vehicle control system of the first aspect, wherein the generation section generates the plan achievability focused course and the safety focused course based on at least an arrival position preset as a vehicle position the vehicle is due to arrive at in the future, an initial position of the vehicle, and a spline curve with a speed vector of the vehicle as a parameter.

A ninth aspect of the disclosure describes the vehicle control system of the eighth aspect, wherein the generation section changes the arrival position preset as a vehicle position the vehicle is due to arrive at in the future to generate plural plan achievability focused courses and safety focused courses.

A tenth aspect of the disclosure describes the vehicle control system of the first aspect, wherein the evaluation/selection section evaluates the safety focused course and the plan achievability focused course based on two references, these being a safety index for evaluating factors including a spacing between the vehicle and nearby objects, and a plan achievability index for evaluating factors including fidelity to a top-ranked generated plan.

An eleventh aspect of the disclosure describes a vehicle control method wherein a computer: detects a nearby object present in the surroundings of a vehicle; generates a safety focused course focusing on safety and a plan achievability focused course focusing on fidelity to a preset plan, based on a position of the detected nearby object; selects one course from out of the safety focused course or the plan achievability focused course generated by the generation section, based on a situation in the surroundings in which the vehicle is present; and automatically controls at least one from out of acceleration/deceleration or steering of the vehicle based on the selected course.

A twelfth aspect of the disclosure describes a vehicle control program that causes a computer to: detect a nearby object present in the surroundings of a vehicle; generate a safety focused course focusing on safety and a plan achievability focused course focusing on fidelity to a preset plan, based on a position of the detected nearby object; select one course from out of the safety focused course or the plan achievability focused course generated by the generation section, based on a situation in the surroundings in which the vehicle is present; and automatically control at least one from out of acceleration/deceleration or steering of the vehicle based on the selected course.

In the first to fourth, eleventh, and twelfth aspects of the disclosure, the evaluation/selection section selects one course from out of the safety focused course focusing on safety or the plan achievability focused course focusing on the fidelity to the preset plan, based on the situation in the surroundings in which the vehicle is present. The travel control section automatically controls at least one from out of the acceleration/deceleration or the steering of the vehicle based on the course selected by the evaluation/selection section, thereby enabling the vehicle travel to be precisely controlled according to the situation in the surroundings.

In the fifth aspect of the disclosure, the evaluation/selection section derives evaluation values of the safety focused course and the plan achievability focused course generated by the generation section, and selects the safety focused course in cases in which the evaluation value of the safety focused course is higher than the evaluation value of the plan achievability focused course by a specific value or greater, even when the derived evaluation value of the plan achievability focused course is a reference value or greater, thereby enabling safety to be sufficiently taken into consideration when controlling the vehicle.

In the sixth aspect of the disclosure, the generation section generates a safety focused course that satisfies plan achievability and a plan achievability focused course that satisfies safety, thereby enabling highly realizable courses to be generated.

In the seventh aspect of the disclosure, the generation section changes plan elements of a plan with a high evaluation value for safety in a direction in which the evaluation value becomes higher to generate the safety focused course based on a plan having a local maximum evaluation value, and changes plan elements of a plan with a high evaluation value for plan achievability in a direction in which the evaluation value becomes higher to generate the plan achievability focused course based on a plan having a local maximum evaluation value, thereby enabling a course with a higher level of safety and a course with a higher level of plan achievability to be generated.

In the eighth and ninth aspects of the disclosure, the generation section generates the plan achievability focused course and the safety focused course based on at least an arrival position preset as a vehicle position the vehicle is due to arrive at in the future, the initial position of the vehicle, and a spline curve with a speed vector of the vehicle as a parameter, thereby enabling a smooth course to be generated.

In the tenth aspect of the disclosure, the evaluation/selection section evaluates the safety focused course and the plan achievability focused course using two references, these being the safety index for evaluating factors including the spacing between the vehicle and nearby objects, and the plan achievability index for evaluating factors including the fidelity to the top-ranked generated plan, thereby enabling the courses to be evaluated more precisely. The word “section” used in this application may mean a physical part or component of computer hardware or any device including a controller, a processor, a memory, etc., which is particularly configured to perform functions and steps disclosed in the application.

### BRIEF DESCRIPTION OF THE DRAWINGS

FIG. 1 is a diagram illustrating configuration elements included in a vehicle installed with a vehicle control system.

FIG. 2 is a functional configuration diagram of a vehicle, focused on a vehicle control system.

FIG. 3 is a diagram illustrating a manner in which a relative position of a vehicle with respect to a lane of travel is recognized by a vehicle position recognition section.

FIG. 4 is a diagram illustrating an example of an action plan generated for a specific road section.

FIG. 5A to FIG. 5D are diagrams each illustrating an example of a course generated by a course generation section.

FIG. 6 is a diagram illustrating an example of a positional relationship between a vehicle and nearby vehicles.

FIG. 7 is a graph illustrating an example of a positional relationship of nearby vehicles predicted by a future state prediction section.

FIG. 8 is a graph illustrating an example of a positional relationship between a vehicle and nearby vehicles when the vehicle changes lanes.

FIG. 9 is a flowchart illustrating a flow of processing executed by a course candidate generation section and an evaluation/selection section.

FIG. 10A and FIG. 10B are graphs for explaining derivation of a safety focused reference course and a plan achievability focused reference course.

FIG. 11 is a diagram illustrating an example of plural plan achievability focused courses and plural safety focused courses.

FIG. 12 is a graph illustrating an example of course determination references based on a safety index and a plan achievability index.

### DESCRIPTION OF THE PREFERRED EMBODIMENTS

Explanation follows regarding an embodiment of a vehicle control system, vehicle control method, and vehicle control program of the present disclosure, with reference to the drawings.

### Vehicle Configuration

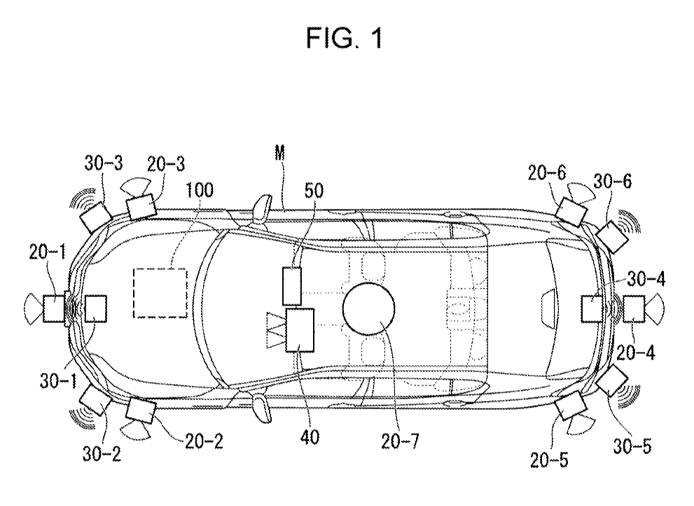

FIG. 1 is a diagram illustrating configuration elements included in a vehicle (referred to below as a vehicle M) installed with a vehicle control system 100 according to the embodiment. The vehicle installed with the vehicle control system 100 is, for example, a two, three, or four-wheeled automobile, and encompasses automobiles with an internal combustion engine such as a diesel engine or a gasoline engine as a motive power source, electric vehicles with an electric motor as a motive power source, and hybrid vehicles including both an electric motor and an internal combustion engine. Such electric vehicles are driven using electric power discharged from a battery such as a secondary battery, a hydrogen fuel cell, a metal fuel cell, or an alcohol fuel cell.

As illustrated in FIG. 1, the vehicle M is installed with sensors such as finders 20-1 to 20-7, radars 30-1 to 30-6, and a camera 40, as well as a navigation device 50 and the vehicle control system 100 described above. The finders 20-1 to 20-7 are, for example, Light Detection and Ranging, or Laser Imaging Detection and Ranging (LIDAR) sensors that measure scattering of illuminated light to measure the distance to a target. For example, the finder 20-1 is attached to a front grille, and the finders 20-2 and 20-3 are attached to side faces or door mirrors of the vehicle body, inside headlights, or in the vicinity of side lights. The finder 20-4 is attached to a trunk lid or the like, and the finders 20-5 and 20-6 are attached to side faces of the vehicle body or inside tail lights. The finders 20-1 to 20-6 described above have, for example, a detection region of approximately 150° in a horizontal direction. The finder 20-7 is attached to the roof, for example. The finder 20-7 has, for example, a detection region of 360° in the horizontal direction.

The radars 30-1 and 30-4 described above are, for example, long range millimeter wave radars that have a wider detection range than the other radars in the depth direction. The radars 30-2, 30-3, 30-5, and 30-6 are mid-range millimeter wave radars that have a narrower detection range than the radars 30-1 and 30-4 in the depth direction. In the following description, finders 20-1 to 20-7 are denoted simply as “finders 20” when no particular distinction is being made therebetween, and the radars 30-1 to 30-6 are denoted simply as “radars 30” when no particular distinction is being made therebetween. The radars 30 detect objects using a frequency-modulated continuous-wave (FM-CW) method, for example.

The camera 40 is, for example, a digital camera utilizing a solid-state imaging element such as a charge-coupled device (CCD) or a complementary metal-oxide-semiconductor (CMOS) element. The camera 40 is, for example, attached to an upper portion of a front windshield or to a back face of a rear view mirror. The camera 40 periodically and repeatedly images in front of the vehicle M, for example.

Note that the configuration illustrated in FIG. 1 is merely an example, and part of this configuration may be omitted, and other configuration may be added.

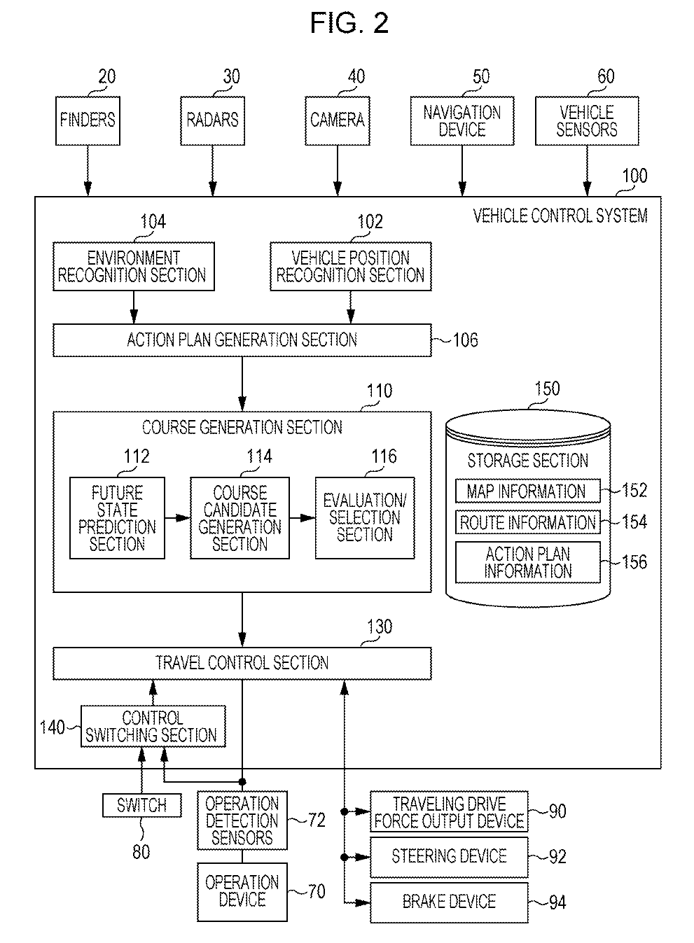

FIG. 2 is a functional configuration diagram of the vehicle M, focusing on the vehicle control system 100. In addition to the finders 20, the radars 30, and the camera 40, the vehicle M is installed with the navigation device 50, vehicle sensors 60, an operation device 70, operation detection sensors 72, a switch 80, a traveling drive force output device 90, a steering device 92, a brake device 94, and the vehicle control system 100. These devices and equipment are connected together through multiple communication lines or serial communication lines such as Controller Area Network (CAN) communication lines, a wireless communications network, or the like.

The navigation device 50 includes a global navigation satellite system (GNSS) receiver and map information (navigation map), a touch-panel display device that functions as a user interface, a speaker, a microphone, and the like. The navigation device 50 identifies the position of the vehicle M using the GNSS receiver, and derives a route from this position to a destination designated by a user. The route derived by the navigation device 50 is stored in a storage section 150 as route information 154. The position of the vehicle M may be identified, or supplemented, by using an inertial navigation system (INS) that utilizes output from the vehicle sensors 60. While the vehicle control system 100 is executing a manual driving mode, the navigation device 50 provides guidance using sounds and navigational display of the route to the destination. Note that configuration for identifying the position of the vehicle M may be provided independently of the navigation device 50. The navigation device 50 may be implemented, for example, by one function of a terminal device such as a smartphone or a tablet terminal belonging to a user. In such cases, information is exchanged using wireless or wired communication between the terminal device and the vehicle control system 100.

The vehicle sensors 60 include sensors such as a speed sensor that detects speed, an acceleration sensor that detects acceleration, a yaw rate sensor that detects angular velocity about a vertical axis, and a direction sensor that detects the orientation of the vehicle M.

The operation device 70 includes, for example, an accelerator pedal, a steering wheel, a brake pedal, and a shift lever. The operation detection sensors 72 that detect the presence or absence of operation and the amount of operation by a driver are attached to the operation device 70. The operation detection sensors 72 include, for example, an accelerator opening sensor, a steering torque sensor, a brake sensor, and a shift position sensor. The operation detection sensors 72 output the degree of accelerator opening, steering torque, brake depression amount, shift position, and the like to a travel control section 130 as detection results. Note that, alternatively, the detection results of the operation detection sensors 72 may be directly output to the traveling drive force output device 90, the steering device 92, or the brake device 94.

The switch 80 is a switch operated by a driver or the like. The switch 80 may be a mechanical switch installed to the steering wheel, garnish (dashboard), or the like, or may be a graphical user interface (GUI) switch provided to the touch-panel of the navigation device 50. The switch 80 receives operation from a driver or the like, and generates a control mode designation signal designating a control mode of the travel control section 130 to be either a self-driving mode or the manual driving mode, and outputs the control mode designation signal to a control switching section 140. As previously described, the self-driving mode is a driving mode for traveling in a state in which a driver does not perform operations (or performs fewer operations, or less frequent operations, than in the manual driving mode). More specifically, the self-driving mode is a driving mode in which some or all of the traveling drive force output device 90, the steering device 92, and the brake device 94 are controlled based on an action plan.

In cases in which the vehicle M is an automobile with an internal combustion engine as a motive power source, the traveling drive force output device 90 includes, for example, an engine, and an engine Electronic Control Unit (ECU) that controls the engine. In cases in which the vehicle M is an electric vehicle with an electric motor as a motive power source, the traveling drive force output device 90 includes a traction motor and a motor ECU that controls the traction motor. In cases in which the vehicle M is a hybrid vehicle, the traveling drive force output device 90 includes an engine and an engine ECU, and a traction motor and a motor ECU. When the traveling drive force output device 90 includes only an engine, the engine ECU adjusts an engine throttle opening amount and a gear shift according to information input from the travel control section 130, described later, so as to output traveling drive force (torque) to make the vehicle travel. When the traveling drive force output device 90 includes only a traction motor, the motor ECU adjusts the duty ratio of a PWM signal given to the traction motor according to information input from the travel control section 130 so as to output the traveling drive force described above. When the traveling drive force output device 90 includes an engine and a traction motor, both the engine ECU and the motor ECU work together to control the traveling drive force according to information input from the travel control section 130.

The steering device 92 includes, for example, an electric motor. The electric motor, for example, applies force to a rack and pinion mechanism or the like to change the orientation of a steering wheel. The steering device 92 drives the electric motor according to information input from the travel control section 130 to change the orientation of the steering wheel.

The brake device 94 is, for example, an electric servo brake device that includes a brake caliper, a cylinder that transmits hydraulic pressure to the brake caliper, an electric motor that causes the cylinder to generate hydraulic pressure, and a braking controller. The braking controller of the electric servo brake device is configured to control the electric motor according to information input from the travel control section 130, and to output brake torque corresponding to a braking operation to each wheel. The electric servo brake device may include a backup mechanism that transmits hydraulic pressure generated by operation of the brake pedal to the cylinder through a master cylinder. Note that the brake device 94 is not limited to the electric servo brake device explained above, and may be an electronically controlled hydraulic brake device. The electronically controlled hydraulic brake device controls an actuator according to information input from the travel control section 130 so as to transmit hydraulic pressure from the master cylinder to the cylinder. The brake device 94 may also include a regenerative brake powered by the traction motor explained with respect to the traveling drive force output device 90.

### Vehicle Control System

Explanation follows regarding the vehicle control system 100. The vehicle control system 100 includes, for example, a vehicle position recognition section 102, an environment recognition section 104, an action plan generation section 106, a course generation section 110, the travel control section 130, the control switching section 140, and the storage section 150. Some or all of the vehicle position recognition section 102, the environment recognition section 104, the action plan generation section 106, the course generation section 110, the travel control section 130, and the control switching section 140 is a software function section that functions by a processor, such as a central processing unit (CPU), executing a program. Moreover, some or all out of these sections may be hardware function section using, for example, Large-Scale Integration (LSI) or Application Specific Integrated Circuits (ASIC). The storage section 150 is implemented by read-only memory (ROM), random-access memory (RAM), a hard disk drive (HDD), flash memory, or the like. The program executed by the processor may be pre-stored in the storage section 150, or may be downloaded from an external device over onboard internet equipment or the like. The program may also be installed in the storage section 150 by loading a portable storage medium stored with the program into a drive device, not illustrated in the drawings.

The vehicle position recognition section 102 recognizes the lane in which the vehicle M is traveling (lane of travel) and the relative position of the vehicle M with respect to the lane of travel based on map information 152 stored in the storage section 150, and information input from the finders 20, the radars 30, the camera 40, the navigation device 50, or the vehicle sensors 60. The map information 152 is, for example, map information that is more precise than the navigation map included in the navigation device 50, and includes information relating to the lane centers, information relating to the lane boundaries, and the like. More specifically, the map information 152 includes information such as road information, traffic restriction information, address information (addresses and zip codes), facilities information, and telephone numbers. The road information includes information indicating the road type, such as expressways, toll roads, national routes, and local routes, and information such as the number of lanes of the road, the width of each lane, the gradient of the road, the position of the road (three-dimensional coordinates indicating latitude, longitude, and altitude), lane curvature, positions of lane merge and junction points, signs provided along the road, and the like. The traffic restriction information includes information such lane closures due to roadwork and traffic accidents, and congestion.

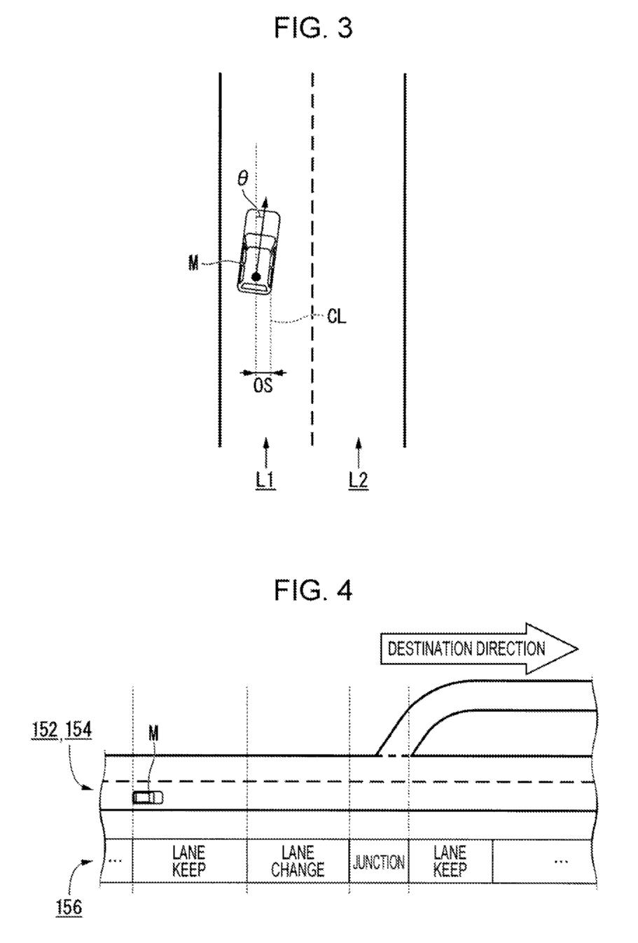

FIG. 3 is a diagram illustrating a manner in which the relative position of the vehicle M is recognized with respect to a lane of travel L1 by the vehicle position recognition section 102. The vehicle position recognition section 102 recognizes, for example, a deviation OS of a reference point (for example, the center of mass) of the vehicle M from a lane of travel center CL, and an angle θ formed between the direction of progress of the vehicle M and a line aligned with the lane of travel center CL, as the relative position of the vehicle M with respect to the lane of travel L1. Note that, alternatively, the vehicle position recognition section 102 may recognize the position of the vehicle M reference point with respect to either of the side edges of the lane of travel L1 as the relative position of the vehicle M with respect to the lane of travel.

The environment recognition section 104 recognizes states such as the position, speed, and acceleration of nearby vehicles based on information input from the finders 20, the radars 30, the camera 40, and the like. In the present embodiment, nearby vehicles refers to vehicles that are traveling in the surroundings of the vehicle M, and that are vehicles traveling in the same direction as the vehicle M. The positions of nearby vehicles may be indicated by representative points such as the centers of mass or corners of nearby vehicles, or may be indicated by regions expressed by the outlines of the nearby vehicles. The “state” of a nearby vehicle may include the acceleration of the nearby vehicle or whether or not the nearby vehicle is changing lanes (whether or not the nearby vehicle is attempting to change lanes), based on information from the various devices described above. The environment recognition section 104 may also recognize the position of guard rails, utility poles, parked vehicles, pedestrians, and other objects in addition to nearby vehicles.

The action plan generation section 106 generates an action plan for specific road sections. Specific road sections are, for example, road sections that pass through toll roads such as expressways in the route derived by the navigation device 50. Note that there is no limitation thereto, and the action plan generation section 106 may generate action plans for freely selected road sections.

The action plan is, for example, configured by plural events that are sequentially executed. Events include, for example, a deceleration event in which the vehicle M is decelerated, an acceleration event in which the vehicle M is accelerated, a lane keep event in which the vehicle M is caused to travel so as not to deviate from the lane of travel, a lane change event in which the lane of travel is changed, a passing event in which the vehicle M is caused to overtake a vehicle in front, a junction event in which the vehicle M is caused to change to a desired lane at a junction point or the vehicle M is caused to travel so as to not leave the current lane of travel, and a merge event in which the vehicle M is accelerated or decelerated toward a lane for merging in order to merge into the lane and the lane of travel is changed. For example, in cases in which a junction (junction point) is present on a toll road (for example, an expressway or the like), in the self-driving mode, it is necessary for the vehicle control system 100 to change lanes such that the vehicle M progresses in the direction of the destination, or to maintain its lane. Accordingly, in cases in which the map information 152 is referenced and a junction is determined to be present on the route, the action plan generation section 106 sets a lane change event between the current position (coordinate) of the vehicle M and the position (coordinate) of the junction in order to change lanes into a desired lane that enables progression in the direction of the destination. Note that information indicating the action plan generated by the action plan generation section 106 is stored in the storage section 150 as action plan information 156.

FIG. 4 is a diagram illustrating an example of an action plan generated for a given road section. As illustrated in the drawing, the action plan generation section 106 classifies situations that arise when traveling along a route to a destination, and generates an action plan such that events adapted to each situation are executed. Note that the action plan generation section 106 may dynamically change the action plan according to changes in the situation of the vehicle M.

The action plan generation section 106 may, for example, change (update) the generated action plan based on the state of the environment recognized by the environment recognition section 104. In general, the state of the environment changes constantly while the vehicle is traveling. In particular, when the vehicle M is traveling along a road with plural lanes, the relative distances to nearby vehicles change. For example, if the vehicle in front brakes suddenly and decelerates, or a vehicle traveling in an adjacent lane cuts in in front of the vehicle M, it is necessary for the vehicle M to travel while changing the speed and lane appropriately to adapt to the behavior of the vehicle in front or the behavior of the vehicle in the adjacent lane. Accordingly, the action plan generation section 106 may change events set for each controlled road section according to the changing state of the environment, as described above.

Specifically, in cases in which the speed of a nearby vehicle recognized by the environment recognition section 104 during vehicle travel exceeds a threshold value, or when the movement direction of a nearby vehicle traveling in a lane adjacent to the lane of travel is heading toward the lane of travel, the action plan generation section 106 changes the events set for the driving road section in which the vehicle M is scheduled to travel. For example, in a case in which events are set so as to execute a lane change event after a lane keep event, if it is found from the recognition results of the environment recognition section 104 that a vehicle is proceeding from the lane rear along the lane change target at a speed of the threshold value or greater during the lane keep event, the action plan generation section 106 changes the event immediately following the lane keep event from a lane change to a deceleration event, a lane keep event, or the like. As a result, the vehicle control system 100 is capable of causing the vehicle M to travel automatically in a safe manner even when a change occurs in the state of the environment.

The course generation section 110 generates a safety focused course focusing on safety, and a plan achievability focused course focusing on fidelity to the plan generated by the action plan generation section 106, based on the positions of nearby objects. The course generation section 110 then selects a course from out of the generated safety focused course or plan achievability focused course based on the situation in the surroundings in which the vehicle is present. In the following explanation, reference is simply made to a course when no particular distinction is being made between the safety focused course and the plan achievability focused course.

The course generation section 110 includes a future state prediction section 112, a course candidate generation section 114, and an evaluation/selection section 116. The future state prediction section 112 predicts a future state of the surrounding environment of the vehicle M. The future state is a state of roads along which the vehicle M may travel in the future, predicted based on the map information 152, for example. The state of a road includes an increase or decrease in the number of lanes, lane junctions, the curvature and direction of curves, and so on. The future state prediction section 112 also predicts future position changes of nearby vehicles for the nearby vehicles recognized by the environment recognition section 104 (see later description).

### Lane Keep Event

The course generation section 110 chooses a travel mode that is one out of constant speed travel, following travel, decelerating travel, curve travel, obstacle avoidance travel, or the like when a lane keep event included in the action plan is executed by the travel control section 130. For example, the course generation section 110 chooses constant speed travel as the travel mode in cases in which nearby vehicles are not present in front of the vehicle. The course generation section 110 chooses following travel as the travel mode in cases such as that in which a vehicle in front is to be followed. Moreover, the course generation section 110 chooses decelerating travel as the travel mode in cases in which the environment recognition section 104 has recognized that the vehicle in front is decelerating, or when executing an event such as stopping or parking. The course generation section 110 chooses curve travel as the travel mode in cases in which the environment recognition section 104 has recognized that the vehicle M is approaching a curved road. The course generation section 110 chooses obstacle avoidance travel as the travel mode in cases in which the environment recognition section 104 has recognized that an obstacle in front of the vehicle M.

The course generation section 110 generates a course based on the chosen travel mode. A course is a collection of points (a path) obtained by sampling, at specific time intervals, future target positions that are envisaged to be reached, in cases in which the vehicle M is traveling based on the travel mode chosen by the course generation section 110.

The course generation section 110 computes a target speed for the vehicle M based on at least the speed of subjects OB present in front of the vehicle M, recognized by the vehicle position recognition section 102 or the environment recognition section 104, and on the distances between the vehicle M and the subjects OB. The course generation section 110 generates a course based on the computed target speed. Subjects OB include a vehicle in front, locations such as merging locations, junction locations, and target locations, as well as objects such as obstacles.

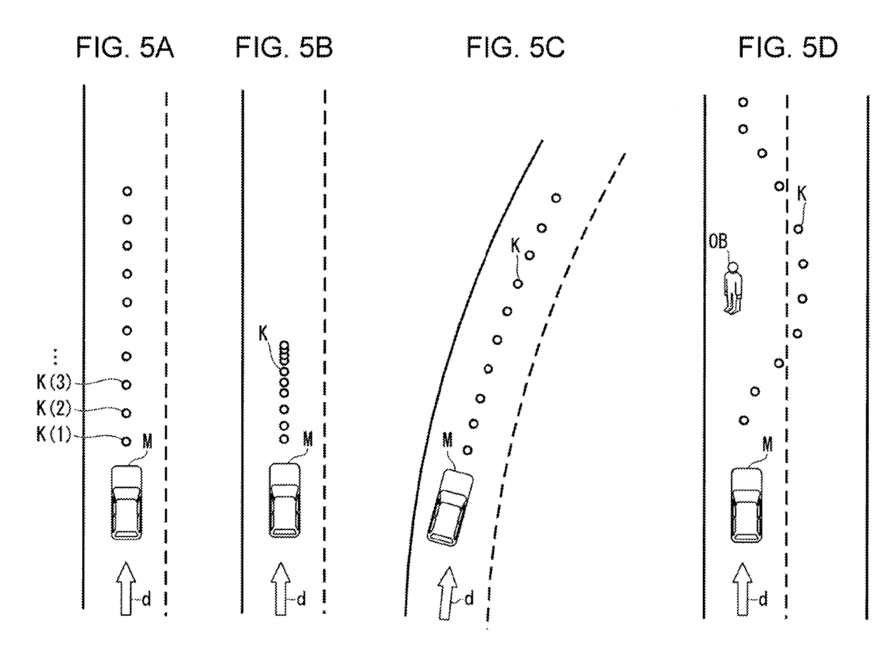

Explanation follows regarding generation of courses, both in cases in which the presence of subjects OB is not particularly taken into consideration, and in cases in which such a presence is taken into consideration. FIG. 5A to FIG. 5D are diagrams illustrating examples of courses generated by the course generation section 110. As illustrated in FIG. 5A, for example, the course generation section 110 sets a row of future target positions (course points) K (1), K (2), K (3), . . . , as the course of the vehicle M each time a specific amount of time Δt has passed, starting from the current time, and using the current position of the vehicle M as a reference. In the following explanation, these target positions are denoted simply as “target positions K” when no particular distinction is being made therebetween. For example, the number of target positions K is chosen according to a target time T. For example, when the target time T is set to 5 seconds, the course generation section 110 sets target positions K on a central line in the lane of travel at intervals of the specific amount of time Δt (for example, 0.1 seconds) for the 5 seconds, and chooses a spacing arrangement for these plural target positions K based on the travel mode. The course generation section 110 may, for example, derive the central line in the lane of travel from information related to the width and the like of the lane included in the map information 152, or may acquire the central line in the lane of travel from the map information 152 in cases in which it is already included in the map information 152.

For example, as illustrated in FIG. 5A, in cases in which constant speed travel has been chosen as the travel mode, the course generation section 110 generates the course by setting the plural target positions K at equal intervals.

As illustrated in FIG. 5B, in cases in which decelerating travel (including following travel when a vehicle in front has decelerated) has been chosen as the travel mode, the course generation section 110 generates the course such that the target positions K to be arrived at earlier are spaced wider apart and target positions K to be arrived at later are spaced closer together. In such cases, sometimes the vehicle in front is set as an subject OB, or a location other than the vehicle in front, such as a merging location, a junction location, or a target location, or an obstacle or the like, is set as an subject OB. The travel control section 130, described later, thereby decelerates the vehicle M since target positions K for the vehicle M to be arrived at later are relatively nearer to the current position of the vehicle M.

As illustrated in FIG. 5C, in cases in which the road is a curved road, the course generation section 110 chooses curve travel as the travel mode. In such cases, the course generation section 110 generates, for example, a course such that plural target positions K are arranged while changing their lateral positions (these being lane width direction positions in a direction that is substantially directly along the direction of progress) with respect to the direction of progress of the vehicle M in accordance with the curvature of the road.

As illustrated in FIG. 5D, in cases in which an obstacle OB, such as a person or a stationary vehicle, is present in the road in front of the vehicle M, the course generation section 110 chooses obstacle avoidance travel as the travel mode. In such cases, the course generation section 110 arranges the plural target positions K to generate the course such that the vehicle M travels avoiding the obstacle OB.

### Lane Change Event

In cases in which a lane change event is executed, the course generation section 110 performs processing to set a target position as the lane change target, determine whether a lane change is possible, predict the future state, generate a lane change course, and evaluate the course. The course generation section 110 may also perform similar processing when a junction event or merge event is executed.

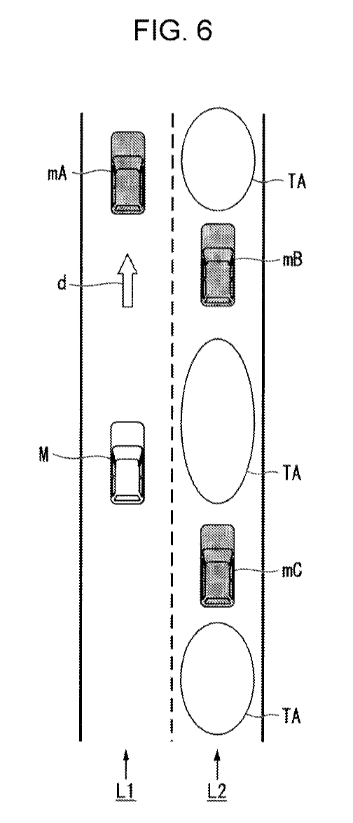

The future state prediction section 112 predicts future states of nearby vehicles. First, the future state prediction section 112 identifies nearby vehicles mA, mB, and mC. FIG. 6 is a diagram illustrating an example of a positional relationship between the vehicle M and the nearby vehicles. In the positional relationship with respect to the direction of progress of the vehicles in FIG. 6, the nearby vehicle mA is foremost, followed by the nearby vehicle mB, then the vehicle M, and the nearby vehicle mC is rearmost. The nearby vehicle mA is a vehicle traveling directly in front of the vehicle M in the lane in which the vehicle M is traveling. The nearby vehicle mB is a vehicle traveling directly ahead in an adjacent lane L2, which is adjacent to the lane in which the vehicle M is traveling. The nearby vehicle mC is a vehicle traveling directly behind the nearby vehicle mB in the adjacent lane L2. In such a situation, the course generation section 110 sets a target area TA that has the nearby vehicle mB and the nearby vehicle mC at the respective front and rear thereof.

Next, the future state prediction section 112 predicts future position changes of the nearby vehicles mA, mB, and mC. For example, the future state prediction section 112 makes predictions based on a constant speed model assuming that the vehicles will travel maintaining their current speed, a constant acceleration model assuming that the vehicles will travel maintaining their current acceleration, a following travel model assuming that the vehicle behind will travel following the vehicle in front while maintaining a specific distance therebetween, and various other models.

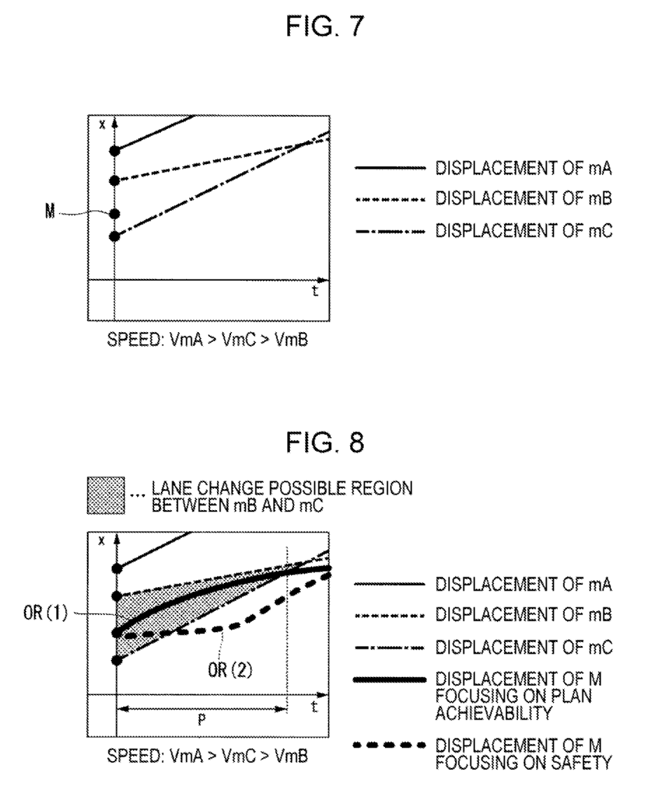

FIG. 7 is a graph illustrating an example of a positional relationship of the nearby vehicles as predicted by the future state prediction section 112. In FIG. 7, the speeds of the nearby vehicles are such that VmA>VmC>VmB. In FIG. 7, the vertical axis denotes displacement (x) with respect to the direction of progress with the vehicle M as a reference, and the horizontal axis denotes time elapsed (t). The illustrated example represents the results predicted by the future state prediction section 112 regarding a state of the nearby vehicles based on the constant speed model.

The course candidate generation section 114 generates plural realizable course candidates for changing lanes based on the future states predicted by the future state prediction section 112. FIG. 8 is a diagram illustrating an example of positional relationships between the vehicle and the nearby vehicles when the vehicle M changes lanes. In the drawing, plural combinations of course candidates, including courses OR (1) and OR (2), have been generated. Course OR (1) is a course when changing lanes to a position between the nearby vehicle mB and the nearby vehicle mC, and course OR (2) is a course when changing lanes to a position behind the nearby vehicle mC.

The course candidate generation section 114 classifies position changes of the vehicle M and the nearby vehicles mA, mB, and mC in order to derive a lane change possible period P corresponding to a region where changing lanes is possible. Next, the course candidate generation section 114 chooses one or more target positions for changing lanes and lane change possible periods corresponding thereto, based on the position changes of the nearby vehicles mA, mB, and mC predicted by the future state prediction section 112. The course candidate generation section 114 chooses end points of the lane change possible periods based on the predicted position changes of the nearby vehicles mA, mB, and mC. For example, the course candidate generation section 114 chooses the end point of the lane change possible period P to be when the nearby vehicle mC catches up to the nearby vehicle mB, and the distance between the nearby vehicle mC and the nearby vehicle mB has become a specific distance. There is no limitation thereto, and the course candidate generation section 114 chooses the lane change possible period P according to the situation, such as a timing at which the nearby vehicle mC overtakes the nearby vehicle mA. Note that the lane change possible period P is a lane change possible period in cases in which a position between the nearby vehicle mB and the nearby vehicle mC is the target position.

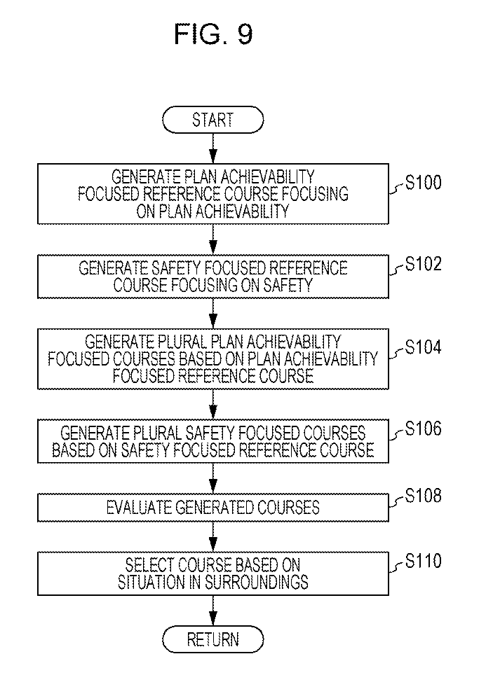

Specific explanation follows in more detail regarding the processing executed by the course candidate generation section 114 and the evaluation/selection section 116. FIG. 9 is a flowchart illustrating a flow of processing executed by the course candidate generation section 114 and the evaluation/selection section 116.

First, the course candidate generation section 114 generates a plan achievability focused reference course focusing on plan achievability (fidelity to the plan) (step S100). The plan achievability focused reference course is, for example, a course for changing lanes so as to be highly faithful to the plan generated by the action plan generation section 106, and/or to have small change amounts in acceleration and steering angle. For example, the higher the fidelity to the action plan generated by the action plan generation section 106, and/or the shorter the course, the higher the plan achievability is evaluated. Moreover, for example, the smaller the change amounts in acceleration, steering angle, and so on in order to travel following the course, the higher the plan achievability is evaluated. Moreover, for example, the higher the possibility of events being executed at the event implementation timing of the action plan generated by the action plan generation section 106, the higher the fidelity to the events is evaluated.

Next, the course candidate generation section 114 generates a safety focused reference course focusing on safety (step S102). The safety focused reference course is a course for lane changing focusing, for example, on having sufficient distances between the vehicle M and nearby vehicles. For example, the further the distances between the vehicle M and objects (such as nearby vehicles), the higher the safety is evaluated. Note that, the smaller the change amounts in acceleration, steering angle, and the like, the higher the safety may be evaluated.

Note that “a point in time at which the vehicle M would be positioned between the nearby vehicle mB and the nearby vehicle mC” and “a point in time at which the vehicle M would be positioned behind the nearby vehicle mC” are factors for choosing a start point for changing lanes as illustrated in FIG. 8, and hypotheses regarding the acceleration/deceleration of the vehicle M are required in order to handle these factors. Regarding this point, the course candidate generation section 114 derives a course with the legal speed limit as an upper limit and a constraint that there is no rapid acceleration from the current speed of the vehicle M, and chooses “a point in time at which the vehicle M would be positioned between the nearby vehicle mB and the nearby vehicle mC” factoring in position changes of the nearby vehicle mB and the nearby vehicle mC. In contrast, in the case of deceleration, for example, the course candidate generation section 114 derives a course with a specific amount of deceleration (such as approximately 20%) from the current speed of the vehicle M with a constraint that there is no rapid deceleration, and chooses “a point in time at which the vehicle M would be positioned behind the nearby vehicle mC” factoring in position changes of the nearby vehicle mC.

When changing lanes, from the perspective of plan achievability, it is desirable that there be no meaningless or unnecessary travel trajectories such as that in which the vehicle M is moved left and then moved right, and that time lost transitioning from deceleration to acceleration be reduced as much as possible. From the perspective of safety, it is desirable that the change amounts in acceleration, steering angle, and so on of the vehicle M are as small as possible, and that lane changing is performed with sufficient distances between the vehicle M and nearby vehicles. The course candidate generation section 114 generates the safety focused reference course and the plan achievability focused reference course based on the above perspectives. Thus, for example, the safety focused reference course can be defined as a traveling course considered to be safer than the plan achievability focused reference course, maintaining a sufficiently safe distance from the nearby vehicles while preferably minimizing the necessary action or behavior of the vehicle M to keep the safety, but to be less efficient than the plan achievability focused reference course to follow the planed course due to the necessary deviation from the planed course. The plan achievability focused reference course can typically be considered to be an ideal course for traveling with regardless of the presence of the nearby vehicles in the surroundings.

In the example in FIG. 8 previously described, for example, a lane changing course with a position between the nearby vehicle mB and the nearby vehicle mC as the lane changing position may be said to be a course focusing on plan achievability. In FIG. 8, the course OR (1) corresponds to this course. In this case, although sufficient distances between the vehicle M, and the nearby vehicle mB and the nearby vehicle mC, are not secured, lane changing can be quickly performed without the vehicle M greatly accelerating or decelerating, and so plan achievability is high.

In contrast thereto, for example, a lane changing course with a position behind the nearby vehicle mC as the lane changing target position may be said to be a course focusing on safety. In FIG. 8, the course OR (2) corresponds to this course. In this case, although the plan achievability is low since the vehicle M is decelerated to change lanes, safety is increased since sufficient distances from nearby vehicles are secured.

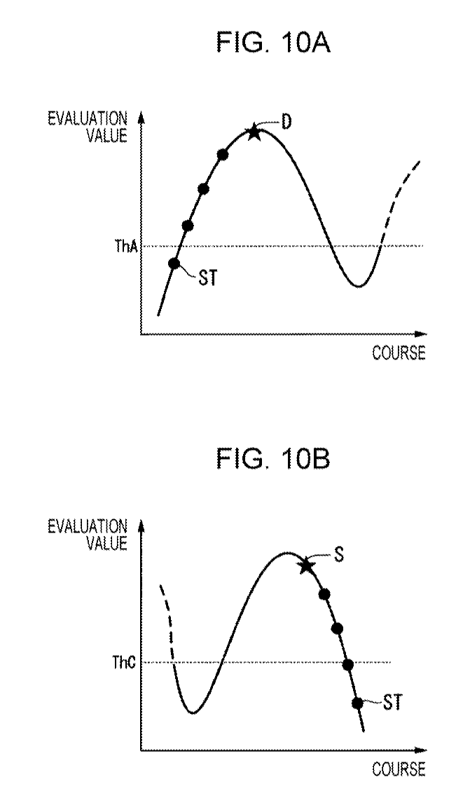

FIG. 10A and FIG. 10B are graphs for explaining derivation of the safety focused reference course and the plan achievability focused reference course. FIG. 10A is a graph schematically denoting a correspondence relationship between evaluation values for plan achievability, and courses. The vertical axis denotes evaluation values for plan achievability and the horizontal axis denotes plural courses.

For example, the course candidate generation section 114 derives the plan achievability and the safety of a generated course based on a predetermined algorithm. The predetermined algorithm is, for example, an evaluation algorithm for deriving plan achievability and safety, based on the degree of fidelity to the action plan, distances between the vehicle M and nearby vehicles, acceleration/deceleration of the vehicle M, change amounts in steering angle, and so on (course elements).

The course candidate generation section 114 derives a course such that the evaluation value for plan achievability is a local maximum, using a single, randomly derived course as a start point ST, for example. The course candidate generation section 114 sequentially changes the course along a specific directionality, for example, and continues to change the course as long as the evaluation value continues to improve (or for a specific number of processes). When the evaluation value has reached a maximum value, the course is established as a local optimum course D.

Note that in cases in which the course candidate generation section 114 is unable to derive a course having an evaluation value for plan achievability of a threshold value ThA or greater after having repeated the processing for a specific duration, the course candidate generation section 114 determines that a course with a maximum evaluation for plan achievability cannot be obtained. In such cases, the course candidate generation section 114 may enter a standby state, or perform processing such as resetting the target position.

In cases in which the selected course D, which has the maximum evaluation value for plan achievability, has an evaluation value for safety that is less than a threshold value ThB, another course with an evaluation value for safety of the threshold value ThB or greater that has a maximum evaluation value for plan achievability may be selected instead of selecting the course D that has the maximum evaluation value for plan achievability. The threshold value ThB is a value that is smaller than the threshold value ThA, for example.

FIG. 10B is a graph schematically illustrating a correspondence relationship between evaluation values for safety, and courses. The vertical axis denotes evaluation values for safety and the horizontal axis denotes plural courses. The course candidate generation section 114 derives the plan achievability and safety of generated courses based on a predetermined algorithm. The predetermined algorithm may, for example, be the same evaluation algorithm for deriving plan achievability and safety as that described above, or may be different thereto.

For example, the course candidate generation section 114 derives a course such that the evaluation value for safety is a local maximum using a single, randomly derived course as a start point ST, by a similar method to the method described above for deriving a course such that the evaluation value for plan achievability is a local maximum.

Note that in cases in which the course candidate generation section 114 is unable to derive a course having an evaluation value for safety of a threshold value ThC or greater after having repeated the processing for a specific duration, the course candidate generation section 114 determines that a course with a maximum evaluation for safety cannot be obtained. In such cases, the course candidate generation section 114 may enter a standby state, or perform processing such as resetting the target position.

In cases in which a selected course S, which has the maximum evaluation value for safety, has an evaluation value for plan achievability that is less than a threshold value ThD, another course with an evaluation value for plan achievability of the threshold value ThD or greater that has a maximum evaluation value for safety may be selected instead of selecting the course S that has the maximum evaluation value for safety. The threshold value ThD is a value that is smaller than the threshold value ThC, for example.

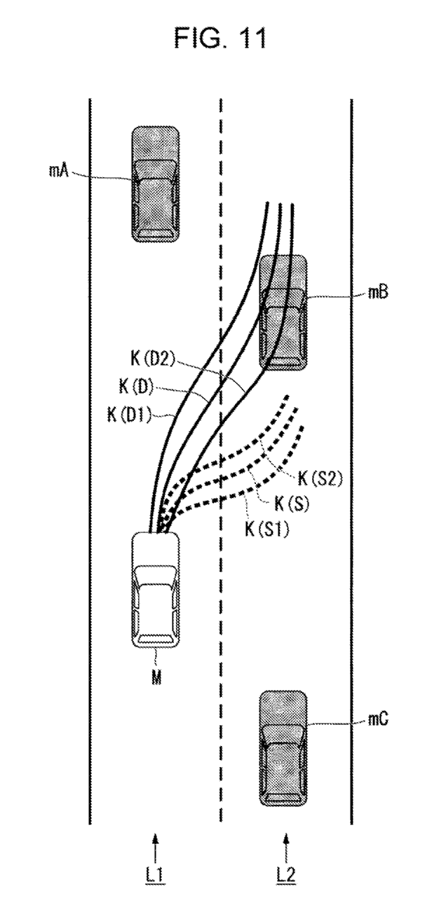

Next, the course candidate generation section 114 generates plural plan achievability focused courses based on the plan achievability focused reference course (step S104). The course candidate generation section 114 then generates plural safety focused courses based on the safety focused reference course (step S106). FIG. 11 is a diagram illustrating an example of plural plan achievability focused courses and plural safety focused courses. The course candidate generation section 114 generates plural plan achievability focused courses K(D1), K(D2) so as to incorporate (or centered on) a plan achievability focused course K(D) corresponding to the plan achievability focused reference course. The course candidate generation section 114 also generates plural safety focused courses K(S1), K(S2) so as to incorporate (or centered on) a safety focused course K(S) corresponding to the safety focused reference course. The safety focused reference course is a course in which the nearby vehicle mC would be ahead of the vehicle M at the timing at which the vehicle M were to move into the right lane.

For example, the course candidate generation section 114 generates plan achievability focused courses and safety focused courses by employing a polynomial curve such as a spline curve to smoothly link the current position of the vehicle M, the lane center of the lane change destination, and a lane change end point, and arranges a specific number of target positions K on this curve at equal intervals or at unequal intervals. The course candidate generation section 114 generates the plan achievability focused courses and the safety focused courses based on, for example, at least a preset arrival position serving as a position the vehicle M is due to arrive at in the future, the current position of the vehicle M, and the spline curve with a speed vector of the vehicle M as a parameter. The course candidate generation section 114 changes the preset arrival position serving as a position the vehicle M is due to arrive at in the future to generate the plural plan achievability focused courses and safety focused courses.

Next, the evaluation/selection section 116 evaluates each course using course determination references based on a safety index and a planning index (step S108), and selects one of each course.

The evaluation/selection section 116 selects the courses from out of the plural courses generated by the course candidate generation section 114 based on safety and plan achievability. For example, the evaluation/selection section 116 selects courses with high evaluation values based on an evaluation function f in Equation (1) below. w₁ (equal to (w+1)⁻¹) and w₂ are weighting coefficients, e₁ is a safety index, and e₂ is a plan achievability index. The safety index is an evaluation value chosen based on, for example, distances between the vehicle M and nearby vehicles (nearby objects), acceleration/deceleration and steering angle at each point of the course, and the envisaged yaw rate. For example, the further the distances between the vehicle M and nearby vehicles, and the smaller the change amounts in acceleration/deceleration, steering angle, and so on, the higher the safety index is evaluated. The plan achievability index is an evaluation value based on the fidelity to the action plan generated by the action plan generation section 106, and/or the shortness of the course.

In cases in which the action plan generation section 106 has chosen to “travel in the central lane, and change lanes to the right before the junction point”, the evaluation/selection section 116 determines that courses in which there is a lane change to the left partway, or in which the vehicle M keeps in lane, have a low plan achievability index. Courses in which there is a lane change to the left partway also have a lower evaluation by the evaluation/selection section 116 from the perspective of the shortness of the course. In the processing by the course generation section 110, the greater the deviation from the action plan generated by the action plan generation section 106, the lower the plan achievability index is determined to be. For example, the less smooth the course or the longer the course, the lower the plan achievability index is evaluated to be by the evaluation/selection section 116.

f=w₁e₁(w₂e₂+1) (1)

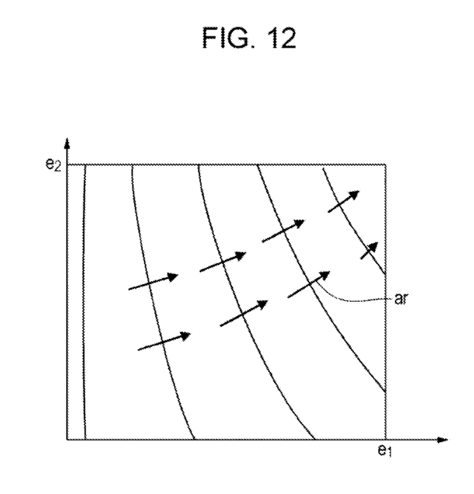

FIG. 12 is a graph indicating an example of course determination references based on the safety index and the plan achievability index. The vertical axis denotes the plan achievability index, and the horizontal axis denotes the safety index. In this graph, the evaluation functions f have slopes in which the evaluation becomes higher along the arrow ar direction. The evaluation of courses with extremely low safety indexes can made lower than in cases in which f is found using a simple weighted sum such as f*=w₁e₁+w₂e₂, for example, enabling such courses to be excluded from consideration. This enables the evaluation/selection section 116 to evaluate the courses taking plan achievability into account, while also sufficiently taking safety into consideration.

Next, the evaluation/selection section 116 selects a course based on the situation in the surroundings of the vehicle M (step S110). For example, in cases in which the evaluation/selection section 116 has envisaged the vehicle M traveling along the plan achievability focused course, when the spacing between the vehicle M and nearby vehicles (nearby objects) is a specific distance or greater (when there is no interference between the vehicle M and nearby vehicles), and the behavior of the vehicle M (change amounts in acceleration/deceleration and steering angle) does not exceed a set range, the plan achievability focused course is preferentially selected. In contrast thereto, when the spacing between the vehicle M and nearby vehicles (nearby objects) is less than the specific distance, or the behavior of the vehicle M exceeds the set range, the evaluation/selection section 116 preferentially selects the safety focused course. Thus, the processing of the present flowchart ends.

Note that in cases in which there is interference or the set range is exceeded in both the plan achievability focused course and the safety focused course, the evaluation/selection section 116 may go into standby, perform processing to reset the target position, or the like.

In the processing of step S110 described above, in cases in which the vehicle M is envisaged to travel on the plan achievability focused course, when the spacing between the vehicle M and nearby vehicles (nearby objects) is a specific distance or greater and the behavior of the vehicle M does not exceed the set range, the plan achievability focused course is preferentially selected. In cases in which the spacing between the vehicle M and nearby vehicles is less than the specific distance, or the behavior of the vehicle M exceeds the set range, the safety focused course is preferentially adopted. However, there is no limitation thereto, and the evaluation/selection section 116 may select the safety focused course in cases in which the evaluation value of the one plan achievability focused course selected at step S108 is less than a reference value.

In cases in which the vehicle M is envisaged to travel along the plan achievability focused course, even when the spacing between the vehicle M and nearby vehicles (nearby objects) is a specific distance or greater and the behavior of the vehicle M (change amounts in acceleration/deceleration and steering angle) does not exceed a set range, the evaluation/selection section 116 may select the safety focused course in cases in which the evaluation value of the safety focused course is higher than the evaluation value of the plan achievability focused course by a specific value or greater. Moreover, even when the evaluation value of the one plan achievability focused course selected at step S108 is a reference value or greater, the safety focused course may be selected in cases in which the evaluation value of the safety focused course is higher than that of the plan achievability focused course by a specific value or greater.

Note that, in addition to the safety focused course and the plan achievability focused course, the course candidate generation section 114 may also generate an emergency response focused course in advance. Although this emergency response focused course is not normally taken into consideration, the course candidate generation section 114 may select the emergency focused course rather than the safety focused course and the plan achievability focused course in cases in which emergency avoidance is required. The emergency response focused course is a course that restricts the behavior of the vehicle M when a different situation than that predicted by the future state prediction section 112 is envisaged as the situation of the nearby vehicles. For example, the course candidate generation section 114 envisages a state in which a nearby vehicle traveling in front of the vehicle M suddenly decelerates, and generates a course for avoiding the nearby vehicle when the nearby vehicle has suddenly decelerated. The evaluation/selection section 116 then selects, for example, one course from out of the plan achievability focused course, the safety focused course, and the emergency response focused course generated by the course candidate generation section 114 based on the situation in the surroundings in which the vehicle M is present.

In the present embodiment, generation of the safety focused course corresponding to the lane change event and the plan achievability focused course corresponding to the lane change event has been explained as an example. However, the safety focused course and the plan achievability focused course may be similarly generated for other events.

### Travel Control

The travel control section 130 sets the control mode to the self-driving mode or the manual driving mode under the control of the control switching section 140, and controls control targets including some or all of the traveling drive force output device 90, the steering device 92, and the brake device 94 according to the set control mode. In the self-driving mode, the travel control section 130 reads the action plan information 156 generated by the action plan generation section 106, and controls the control targets based on the events included in the read action plan information 156.

For example, in cases in which the event is a lane keep event, the travel control section 130 chooses an electric motor control amount (such as the number of rotations) by the steering device 92, and an ECU control amount (for example, a throttle opening amount of the engine and a gear shift) by the traveling drive force output device 90, according to the course generated by the course generation section 110. Specifically, based on distances between target positions K on a course, and specific durations Δt when the target positions K are arranged, the travel control section 130 derives the speed of the vehicle M for each specific duration Δt, and chooses the ECU control amount by the traveling drive force output device 90 according to the speed for each specific duration Δt. Moreover, the travel control section 130 chooses the electric motor control amount by the steering device 92 according to an angle formed by the direction of progress of the vehicle M at each target position K, and the direction of the next target position using the present target position as a reference.

In cases in which the event is a lane change event, the travel control section 130 chooses an electric motor control amount by the steering device 92 and an ECU control amount by the traveling drive force output device 90, according to the course generated by the course generation section 110.

The travel control section 130 outputs information indicating control amounts chosen for each event to the corresponding control targets. Accordingly, the respective control target devices (90, 92, 94) can control their own device according to the information indicating control amounts input from the travel control section 130. Moreover, the travel control section 130 adjusts the chosen control amounts as appropriate based on the detection results of the vehicle sensors 60.

In the manual driving mode, the travel control section 130 controls the control targets based on operation detection signals output by the operation detection sensors 72. For example, the travel control section 130 outputs unaltered operation detection signals output by the operation detection sensors 72 to each control target device.

The control switching section 140 switches the control mode of the vehicle M by the travel control section 130 from the self-driving mode to the manual driving mode, or from the manual driving mode to the self-driving mode, based on the action plan information 156 generated by the action plan generation section 106 and stored in the storage section 150. The control switching section 140 also switches the control mode of the vehicle M by the travel control section 130 from the self-driving mode to the manual driving mode, or from the manual driving mode to the self-driving mode, based on the control mode designation signals input from the switch 80. Namely, the control mode of the travel control section 130 may be changed as desired by operation by a driver or the like during travel or when the vehicle is stationary.

The control switching section 140 also switches the control mode of the vehicle M by the travel control section 130 from the self-driving mode to the manual driving mode based on operation detection signals input from the operation detection sensors 72. For example, when an operation amount included in the operation detection signals exceeds a threshold value, namely, when an operation by an operation amount exceeding a threshold value has been received by the operation device 70, the control switching section 140 switches the control mode of the travel control section 130 from the self-driving mode to the manual driving mode. For example, during autonomous travel of the vehicle M by the travel control section 130 that has been set to the self-driving mode, when the steering wheel, accelerator pedal, or brake pedal are operated by a driver by an operation amount exceeding the threshold value, the control switching section 140 switches the control mode of the travel control section 130 from the self-driving mode to the manual driving mode. This thereby enables the vehicle control system 100 to switch immediately to the manual driving mode, without requiring operation of the switch 80, in response to sudden operation by the driver when, for example, an object such as a person dashes out into the road, or the nearby vehicle mA comes to a sudden stop. As a result, the vehicle control system 100 is capable of responding to operation by the driver in an emergency, thereby enabling an increase in travel safety.

The vehicle control system 100 of the present embodiment explained above generates a safety focused course focusing on safety and a plan achievability focused course focusing on the fidelity to a preset plan, based on the position of nearby objects. The vehicle control system 100 selects one course from out of the safety focused course or the plan achievability focused course, based on the situation in the surroundings in which the vehicle M is present, thereby enabling the travel of the vehicle M to be precisely controlled according to the situation in the surroundings.

Explanation has been given regarding an embodiment for implementing the present disclosure. However, the present disclosure is in no way limited to this embodiment, and various modifications or substitutions may be implemented within a range that does not depart from the spirit of the present disclosure.

What is claimed is:

1. A vehicle control system comprising:
a detection section configured to detect a nearby object present in surroundings of a vehicle;
a course generation section that generates a safety focused course focusing on safety and a plan achievability focused course focusing on plan achievability of a predetermined course plan, based on a position of the nearby object detected by the detection section;
an evaluation/selection section configured to select one course from out of the safety focused course or the plan achievability focused course generated by the course generation section, based on a situation in the surroundings of the vehicle; and
a travel control section configured to automatically control at least one from out of acceleration/deceleration or steering of the vehicle based on the course selected by the evaluation/selection section.

2. The vehicle control system of claim 1, wherein
the evaluation/selection section determines said situation in the surroundings of the vehicle based on possibility of collision with the nearby object and behavior of the vehicle required to prevent the collision in cases in which the vehicle is assumed to travel on the plan achievability focused course, and
the evaluation/selection section selects the plan achievability focused course generated by the course generation section when it is determined that the vehicle assumed to travel on the plan achievability focused course does not collide with nearby object and that the behavior of the vehicle does not exceed a predetermined range.

3. The vehicle control system of claim 2, wherein
the evaluation/selection section selects the safety focused course generated by the course generation section instead of the plan achievability focused course generated by the course generation section when it is determined that the vehicle collides with the nearby object or that the behavior of the vehicle exceeds the predetermined range.

4. The vehicle control system of claim 1, wherein
the evaluation/selection section derives an evaluation value of the plan achievability focused course generated by the course generation section, and selects the safety focused course in cases in which the derived evaluation value of the plan achievability focused course is less than a predetermined threshold value.

5. The vehicle control system of claim 1, wherein
the evaluation/selection section derives respective evaluation values of the safety focused course and the plan achievability focused course generated by the course generation section, and selects the safety focused course in cases in which the evaluation value of the safety focused course is higher than the evaluation value of the plan achievability focused course by a specific value or greater, even when the derived evaluation value of the plan achievability focused course is equal to or greater than the threshold value.

6. The vehicle control system of claim 1, wherein
the course generation section generates the safety focused course based on a reference course focusing on safety that has a specific evaluation value or greater for the plan achievability, and generates the plan achievability focused course based on a reference course focusing on the plan achievability that has a specific evaluation value or greater for safety; and
the evaluation/selection section selects one course from out of the safety focused course or the plan achievability focused course generated by the course generation section, based on a situation in the surroundings of the vehicle.

7. The vehicle control system of claim 1, wherein the course generation section is further configured to:
generate course elements to define a reference course;
changes the course elements of the reference course in a direction in which the evaluation value for safety becomes higher and generate the safety focused course based on the reference course having a maximum evaluation value for safety among the generated reference courses; and
change the course elements of the reference course in a direction in which the evaluation value for plan achievability becomes higher and generate the plan achievability focused course based on the reference course having a maximum evaluation value for plan achievability among the generated reference courses.

8. The vehicle control system of claim 1, wherein
the course generation section generates the plan achievability focused course and the safety focused course based on at least a predetermined target position for the vehicle to arrive, an initial position of the vehicle, and a spline curve with a speed vector of the vehicle as a parameter.

9. The vehicle control system of claim 8, wherein
the course generation section changes the target position for the vehicle to arrive to generate a plurality of the plan achievability focused courses and the safety focused courses.

10. The vehicle control system of claim 1, wherein
the evaluation/selection section evaluates the safety focused course and the plan achievability focused course based on two references which are a safety index for evaluating factors including a distance between the vehicle and the nearby object and a plan achievability index for evaluating factors including the plan achievability to follow the predetermined course plan.

11. A vehicle control method by performed by a computer, the method comprising:
detecting a nearby object present in the surroundings of a vehicle;
generating a safety focused course focusing on safety and a plan achievability focused course focusing on plan achievability of a predetermined course plan, based on a position of the detected nearby object;
selecting one course from out of the generated safety focused course or the generated plan achievability focused course, based on a situation in the surroundings of the vehicle; and
automatically controlling at least one from out of acceleration/deceleration or steering of the vehicle based on the selected course.

12. A vehicle control program that causes a computer to perform the steps of:
detecting a nearby object present in the surroundings of a vehicle;
generating a safety focused course focusing on safety and a plan achievability focused course focusing on plan achievability of a predetermined course plan, based on a position of the detected nearby object;
selecting one course from out of the generated safety focused course or the generated plan achievability focused course, based on a situation in the surroundings of the vehicle; and
automatically controlling at least one from out of acceleration/deceleration or steering of the vehicle based on the selected course.
